(19) United States
(12) Patent Application Publication
(10) Pub. No.: US 2024/0317089 A1
(43) Pub. Date: Sep. 26, 2024

(54) ELECTRIC VEHICLE

(71) Applicant: TOYOTA JIDOSHA KABUSHIKI KAISHA, Toyota-shi Aichi-ken (JP)

(72) Inventor: Kenichi Saito, Nisshin-shi Aichi-ken (JP)

(73) Assignee: TOYOTA JIDOSHA KABUSHIKI KAISHA, Toyota-shi Aichi-ken (JP)

(21) Appl. No.: 18/612,245

(22) Filed: Mar. 21, 2024

(30) Foreign Application Priority Data
Mar. 24, 2023 (JP) 2023-048911

(51) Int. Cl. B60L 53/22; B60L 53/62; B60L 58/20

(52) U.S. Cl. CPC B60L 53/22; B60L 53/62; B60L 58/20; B60L 2210/14; B60L 2240/80

(57) ABSTRACT

An electric vehicle including a charger configured to charge a high-voltage battery with an electric power supplied from an external power source. The charger is disposed on an electric path that is to be connected to and disconnected from the high-voltage battery by switching of a relay. When the high-voltage battery is to be charged by the charger, a control apparatus executes a charging-start-stage control by which a closed state of the relay is maintained until a predetermined time elapses after the relay is switched to the closed state in response to connection of the external power source, wherein the predetermined time is predetermined as a period in which the charger actually starts charging the high-voltage battery and a voltage of battery cells included in the high-voltage battery is increased.

### CROSS-REFERENCE TO RELATED APPLICATION

This application claims priority from Japanese Patent Application No. 2023-048911 filed on Mar. 24, 2023, the disclosure of which is herein incorporated by reference in its entirety.

### TECHNICAL FIELD

The present disclosure relates to an electric vehicle in which a high-voltage battery is charged with an electric power supplied from an external power source.

### BACKGROUND

There is well-known an electric vehicle including: (a) an electric motor; (b) a driving high-voltage battery including a plurality of battery cells connected in series; (c) an electric-power control device which includes an electric-voltage converter configured to reduce a voltage of a DC electric power supplied from the high-voltage battery and to supply the electric power to a low-voltage battery and vehicle auxiliary devices, and which is configured to control the electric power transmitted and received between the battery and the electric motor; (c) a relay that is to be switched between an open state and a closed state, such that an electric path between the high-voltage battery and the electric-power control device is cut off when the relay is placed in the closed state, and is established when the relay is placed in the closed state; (d) a charger configured to charge the high-voltage battery with the electric power supplied from an external power source; and (e) a control apparatus configured to control charge of the high-voltage battery. For example, a hybrid electric vehicle described in Patent Document 1 is such an electric vehicle. This patent document 1 discloses that the charger is connected to the high-voltage battery via a dedicated charging relay without via a main relay (corresponding to the above-described relay).

### PRIOR ART DOCUMENT

### Patent Document

[Patent Document 1]
Japanese Patent Application Laid-Open No. 2015-104222

### SUMMARY

Here, from a viewpoint of cost, it is conceivable to eliminate the dedicated charging relay and dispose the charger in an electric path that is to be connected to and disconnected from the high-voltage battery by switching of the main relay. Further, when the voltage of the battery cells of the high-voltage battery is lower than a predetermined abnormally low voltage value, it is considered to switch the main relay to the open state in order to prevent the electric power from being taken out from the high-voltage battery and to suppress durability of the battery cells from being reduced due to a further voltage drop. When the external power source is connected to charge the high-voltage battery by the charger, the relay needs to be switched to the closed state. In this case, when the voltage converter is operated in conjunction with the switching of the relay to the closed state, the electric power is taken out from the high-voltage battery. At this time, when the voltage of the battery cells is reduced to be lower than the predetermined abnormally low voltage value due to the electric power being taken out, the main relay is switched to the open state, so that the high-voltage battery cannot be charged by the charger. In this case, the open state of the main relay due to the voltage drop of the battery cells is continued, so that the charger cannot charge the high-voltage battery in the arrangement in which the charger is disposed in the electric path that is to be connected to and disconnected from the high-voltage battery by switching of the main relay, and accordingly the voltage of the battery cell may not be recovered.

The present disclosure has been made in view of the above circumstances, and an object of the present disclosure is to provide an electric vehicle in which a high-voltage battery can be appropriately charged by a charger which is arranged in parallel with an electric-power control device and which is disposed on an electric path that is to be connected to and disconnected from the high-voltage battery by switching of a relay.

The present disclosure provides an electric vehicle including: (a) an electric motor; (b) a driving high-voltage battery including a plurality of battery cells connected in series; (c) an electric-power control device which includes an electric-voltage converter configured to reduce a voltage of a DC electric power supplied from the high-voltage battery and to supply the electric power to a low-voltage battery and vehicle auxiliary devices, and which is configured to control the electric power transmitted and received between the high-voltage battery and the electric motor; (d) a relay that is to be switched between an open state and a closed state, such that an electric path between the high-voltage battery and the electric-power control device is cut off when the relay is placed in the open state, and is established when the relay is placed in the closed state; (e) a charger configured to charge the high-voltage battery with the electric power supplied from an external power source; and (f) a control apparatus configured to control charge of the high-voltage battery. The charger is arranged in parallel with the electric-power control device, and is disposed on an electric path that is to be connected to and disconnected from the high-voltage battery by switching of the relay. The control apparatus is configured to cause the electric-voltage converter to be operated when the relay is switched to the closed state. The control apparatus is configured to switch the relay to the open state when a voltage of the battery cells becomes lower than a predetermined low voltage value. The control apparatus is configured, when the high-voltage battery is to be charged by the charger, to execute a charging-start-stage control by which the closed state of the relay is maintained until a predetermined time elapses after the relay is switched to the closed state in response to connection of the external power source, wherein the predetermined time being predetermined as a period in which the charger actually starts charging the high-voltage battery and the voltage of the battery cells is increased.

According to the disclosure, when the charger charges the high-voltage battery, the charging-start-stage control is performed such that the relay is maintained in the closed state until the predetermined time elapses after the relay is switched to the closed state in response to the connection of the external power source. The predetermined time is a threshold value that is predetermined as a period in which the voltage of the battery cell increases after the charger actually starts charging the high-voltage battery. Thus, after the relay is switched to the closed state, the relay is prevented or suppressed from being switched to the open state until the charger actually starts charging the high-voltage battery. Therefore, the high-voltage battery can be appropriately charged by the charger which is arranged in parallel with the electric-power control device and which is disposed on the electric path that is to be connected to and disconnected from the high-voltage battery by switching of the relay.

### BRIEF DESCRIPTION OF THE DRAWINGS

FIG. 1 is a view schematically showing, by way of example, a construction of a vehicle to which the present disclosure is applied.

FIG. 2 is a flowchart for explaining a main part of a control operation of an electronic control apparatus, wherein the control operation is executed for appropriately charging a main battery by an AC charger disposed in an electric path via a main relay.

FIG. 3 is a view showing, by way of example, a time chart in a case where the control operation shown in the flowchart of FIG. 2 is executed.

FIG. 4 is a flowchart for explaining a main part of a control operation of the electronic control apparatus, wherein the control operation is executed for appropriately charging the main battery by the AC charger disposed in the electric path via the main relay, in a manner different from the flowchart of FIG. 2.

FIG. 5 is a view for explaining a comparative example in which the main relay is turned off when BLOW is detected.

### DETAILED DESCRIPTION OF EMBODIMENTS

Hereinafter, embodiments of the present disclosure will be described in detail with reference to the drawings.

### First Embodiment

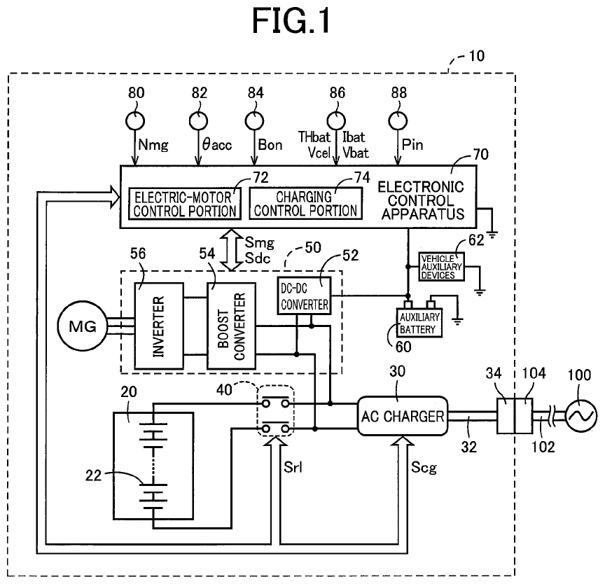

FIG. 1 is a view schematically showing, by way of example, a construction of an electric vehicle 10 to which the present disclosure is applied. As shown in FIG. 1, the electric vehicle 10 includes an electric motor MG that functions as a power source.

The electric motor MG is a known rotary electric machine having a function as a motor that generates a mechanical power from an electric power and a function as a generator that generates the electric power from the mechanical power, and is a so-called motor generator. In the electric vehicle 10, the power from the electric motor MG is transmitted to driving wheels via a power transmission device (not shown).

The electric vehicle 10 further includes a main battery 20, an AC charger 30, an in-vehicle charging cable 32, a charging inlet 34, a main relay 40, an electric-power control unit 50, an auxiliary battery 60, vehicle auxiliary devices 62 and an electronic control apparatus 70, as shown in FIG. 1 that is also a view for explaining an electric arrangement related to controls of the electric motor MG and the main battery 20, for example.

The main battery 20 is a chargeable and dischargeable DC power source, and is a high-voltage battery for driving the electric vehicle 10 (hereinafter simply referred to as “vehicle 10”). The main battery 20 includes a plurality of cells 22, and is a secondary battery such as a nickel-hydrogen cell assembly or a lithium-ion cell assembly in which the plurality of cells 22 are connected in series.

The AC charger 30 is connected to the charging inlet 34 via the in-vehicle charging cable 32. The charging inlet 34 is provided in a vehicle body (that is a body of the vehicle 10) so as to be connectable to a charging connector 104 of an external charging cable 102 connected to an external power source 100 that is a power source outside the vehicle 10. The charging inlet 34 is a terminal into which the charging connector 104 is to be inserted to input an electric power supplied from the external power source 100. The charging inlet 34 is a charging port to be connected to the external power source 100. The AC charger 30 is a charger that charges the main battery 20 with the electric power supplied from the external power source 100. The AC charger 30 converts an alternating current supplied from the external power source 100 into a direct current, and boosts a voltage of the external power source 100 to a voltage equivalent to a voltage of the main battery 20 so as to charge the main battery 20.

The main relay 40 is provided in an electric path between the main battery 20 and the AC charger 30, so as to establish or cut off the electric path. That is, the main relay 40 is a relay that is to be switched between an OFF state, which is an open state in which the electric path between the main battery 20 and the AC charger 30 is cut off, and an ON state, which is a closed state in which the electric path between the main battery 20 and the AC charger 30 is established. In other words, the AC charger 30 is connected to the main battery 20 via the main relay 40.

The electric-power control unit 50 is connected to the main battery 20 via the main relay 40. In other words, the main relay 40 is provided in an electric path between the main battery 20 and the electric-power control unit 50, so as to establish or cut off the electric path. That is, the main relay 40 is a relay that is switched between an OFF state, which is an open state in which the electric path between the main battery 20 and the electric-power control unit 50 is cut off, and an ON state, which is a closed state in which the electric path between the main battery 20 and the electric-power control unit 50 is established. The AC charger 30 is arranged in parallel with the electric-power control unit 50 and is disposed on the electric path that is connected to and disconnected from the main battery 20 by switching of the main relay 40.

The electric-power control unit 50 includes a DC-DC converter 52, a boost converter 54 and an inverter 56. The electric-power control unit 50 is an electric-power control device that controls the electric power transmitted and received between the main battery 20 and the electric motor MG. The stored electric power is supplied from the main battery 20 to the electric motor MG via the electric-power control unit 50. The main battery 20 is supplied with the electric power through the electric-power control unit 50, wherein the electric power is a power generated by the electric motor MG that is subjected to a generation or regeneration control.

The DC-DC converter 52 is connected to the main battery 20 via the main relay 40. The DC-DC converter 52 functions as a charging device that reduces a voltage of the main battery 20 to a voltage equivalent to a voltage of the auxiliary battery 60 and charges the auxiliary battery 60. The DC-DC converter 52 supplies the electric power with the reduced voltage to the vehicle auxiliary devices 62, the electronic control apparatus 70 and the like. The auxiliary battery 60 is a low-voltage battery that supplies the electric power for operating the vehicle auxiliary devices 62, the electronic control apparatus 70 and the like. The vehicle auxiliary devices 62 are auxiliary devices such as a lamp or an audio system. In this way, the DC-DC converter 52 is a voltage converter that reduces the voltage of the DC power supplied from the main battery 20 and supplies the DC power to the auxiliary battery 60 and the vehicle auxiliary devices 62.

The boost converter 54 is connected to the main battery 20 via the main relay 40. The boost converter 54 includes a reactor and a switching element (not shown). The boost converter 54 is a step-up/down circuit having a function of boosting the voltage of the main battery 20 and supplying the boosted voltage to the inverter 56, and a function of reducing the voltage of the direct current (into which the alternating current has been converted by the inverter 56) and supplying the reduced voltage to the main battery 20.

The inverter 56 includes switching elements. The inverter 56 converts the direct current supplied from the boost converter 54, into the alternating current for driving the electric motor MG. The inverter 56 converts the alternating current generated by the electric motor MG by a regenerative brake, into the direct current.

The electronic control apparatus 70 is a controller including a control device that controls charging of the main battery 20. The electronic control apparatus 70 includes a so-called microcomputer including, for example, a CPU, a RAM, a ROM and an input/output interface. The electronic control apparatus 70 performs various controls of the vehicle 10 by the CPU performing signal processing in accordance with programs pre-stored in the ROM while using a temporary storage function of the RAM.

The electronic control apparatus 70 is supplied with various signals (an MG rotational speed Nmg, an accelerator opening degree θacc, a brake-ON signal Bon, a battery temperature THbat, a battery charging/discharging current Ibat, a battery voltage Vbat, a cell voltage Vcel and a plug-in signal Pin, for example) based on detection values of various sensors (such as an MG speed sensor 80, an accelerator opening-degree sensor 82, a brake sensor 84, a battery sensor 86 and a connection detection switch 88) provided in the vehicle 10.

The MG rotational speed Nmg is a signal indicating a rotational speed of the electric motor MG. The accelerator opening degree θacc is a signal indicating a magnitude of an acceleration operation made by a driver of the vehicle 10, i.e., an amount of an accelerator operation made by the driver. The brake-ON signal Bon is a signal indicating a state in which a brake pedal for operating a wheel brake is operated by the driver. The battery temperature THbat is a signal indicating a temperature of the main battery 20. The battery charging/discharging current Ibat is a signal indicating a current charged in the main battery 20 and also a current discharged from the main battery 20. The battery voltage Vbat is a signal indicating the voltage of the main battery 20. The cell voltage Vcel is a signal indicating the voltage of each of the plurality of battery cells 22. The plug-in signal Pin is a signal indicating a state in which the charging connector 104 is connected to the charging inlet 34.

The electronic control apparatus 70 calculates a remaining charge amount SOC [%] based on, for example, the battery charging/discharging current Ibat, the battery voltage Vbat and the like. The remaining charge amount SOC is a remaining charge of the main battery 20, and is a value indicating a state of charge of the main battery 20. The electronic control apparatus 70 calculates a chargeable electric power Win [W] and a dischargeable electric power Wout [W] of the main battery 20 based on, for example, the battery temperature THbat and the remaining charge amount SOC.

The electronic control apparatus 70 outputs various command signals (for example, a charging control command signal Seg for controlling the AC charger 30, a relay control command signal Srl for controlling the main relay 40, a motor control command signal Smg for controlling the electric motor MG, a DC-DC control command signal Sdc for controlling the DC-DC converter 52 and the like) to various devices (for example, the AC charger 30, the main relay 40, the electric-power control unit 50 and the like) provided in the vehicle 10.

The electronic control apparatus 70 includes a motor control, that is, an electric-motor control portion 72, and a charging control, that is, a charging control portion 74, in order to realize various controls in the vehicle 10.

The electric-motor control portion 72 controls the electric motor MG by controlling the boost converter 54 and the inverter 56. For example, the electric-motor control portion 72 converts the direct current supplied from the main battery 20, into the alternating current used for the electric motor MG. The electric-motor control portion 72 drives the electric motor MG based on an output request value corresponding to a driver's request torque. The electric-motor control portion 72 converts the alternating current supplied from the electric motor MG, into the direct current used for charging the main battery 20. The electric-motor control portion 72 causes the electric motor MG so as to function as a generator in accordance with a required amount of regenerative braking.

The electric-motor control portion 72 controls the DC-DC converter 52 so as to charge the auxiliary battery 60 and supply the electric power to the vehicle auxiliary devices 62, the electronic control apparatus 70 and the like. The electric-motor control portion 72 operates the DC-DC converter 52 in conjunction with switching of the main relay 40 to the ON state.

The electric-motor control portion 72 switches the main relay 40 to the ON state in response to power-ON of the vehicle 10.

The charging control portion 74 determines whether the charging connector 104 is connected to the charging inlet 34 based on whether the plug-in signal Pin is present. When the charging control portion 74 determines that the charging connector 104 is connected to the charging inlet 34, the charging control portion 74 switches the main relay 40 to the ON state, and then drives the AC charger 30 so as to charge the main battery 20 by the AC charger 30. As described above, when the main battery 20 is charged by the AC charger 30, the charging control portion 74 switches the main relay 40 to the ON state in response to the connection of the external power source 100, namely, in response to the connection of the AC charger 30 to the external power source 100. In the present embodiment, charge of the main battery 20 by the AC charger 30, that is, charging the main battery 20 by the AC charger 30 is referred to as plug-in charging. The vehicle 10 is a vehicle that can be plug-in charged.

The charging control portion 74 turns off the main relay 40 when the cell voltage Vcel becomes lower than a BLOW threshold value Vcelf in order to suppress a decrease in durability of the main battery 20, particularly, durability of the battery cells 22. BLOW indicates that the battery cells 22 is in an abnormally low voltage state. The BLOW threshold value Vcelf is a predetermined abnormally low voltage, i.e., a predetermined threshold value for determining that the cell voltage Vcel is low enough to easily degrade the durability of the battery cells 22. For example, the charging control portion 74 determines whether or not the cell voltage Vcel is less than the BLOW threshold value Vcelf. When the charging control portion 74 determines that the cell voltage Vcel is less than the BLOW threshold value Vcelf, the charging control portion 74 establishes a BLOW condition. The charging control portion 74 determines whether or not the BLOW condition is continuously satisfied for a detection determination time TMblow, that is, whether or not the BLOW is detected. When the charging control portion 74 determines that BLOW is detected, the charging control portion 74 switches the main relay 40 to the OFF state. The detection determination time TMblow is a predetermined value for reliably determining that the cell voltage Vcel is less than the BLOW threshold value Vcelf, for example.

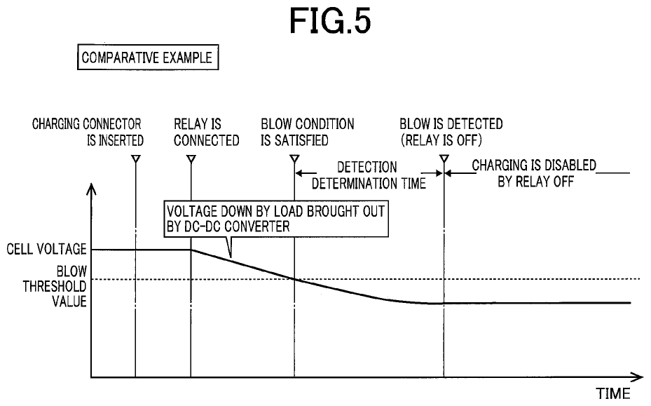

By the way, in the plug-in charging, the DC-DC converter 52 is operated in conjunction with the switching of the main relay 40 to the ON state, and the cell voltage Vcel is reduced by the load brought out by the DC-DC converter 52. At this time, as shown in a comparative example of FIG. 5, if the cell voltage Vcel is close to the BLOW threshold value Vcelf before the start of the plug-in charging, the cell voltage Vcel may be lower than the BLOW threshold value Vcelf due to the operation of the DC-DC converter 52. On the other hand, in the plug-in charging, a charging command is inputted to the AC charger 30 in response to the switching of the main relay 40 to the ON state. However, the AC charger 30 is not driven immediately, and the plug-in charging is actually started after a predetermined preparation time for driving the AC charger 30 has elapsed. If the predetermined preparation time is longer than the detection determination time TMblow, BLOW is detected before the plug-in charging is actually started and the cell voltage Vcel rises, so that the main relay 40 is switched to the OFF state (see FIG. 5). FIG. 5 is a view for explaining the comparative example in contrast to the present embodiment, and shows an example in which the main relay is turned off when the BLOW is detected. The vehicle 10 is not connected to the main battery 20 via a dedicated charging relay, but is connected to the main battery 20 via the main relay 40 as the DC-DC converter 52. Therefore, when the main relay 40 is switched to the OFF state, the plug-in charging is disabled thereafter, and the cell voltage Vcel may not be recovered.

The plug-in charging is started after the predetermined preparation time elapses, and then the cell voltage Vcel is recovered by execution of the plug-in charging. Therefore, the charging control portion 74 does not switch the main relay 40 to the OFF state during the predetermined preparation time. Therefore, in the plug-in charging, the charging control portion 74 determines whether or not a predetermined time TMf has elapsed after the main relay 40 is switched to the ON state in response to the connection of the external power source 100. The predetermined time TMf is a threshold value that is predetermined as a period in which the plug-in charging is actually started and the cell voltage Vcel is increased. The charging control portion 74 executes a charging-start-stage control CNcs by which the ON state of the main relay 40 is maintained until the predetermined time TMf elapses after the main relay 40 is switched to the ON state in response to connection of the external power source 100.

Even if the BLOW is detected during the predetermined time TMf, the charging control portion 74 executes the charging-start-stage control CNcs in which the ON state of the main relay 40 is maintained. That is, the charging control portion 74 executes the charging-start-stage control CNcs by inhibiting the main relay 40 from being switched to the OFF state based on the BLOW threshold value Vcelf. On the other hand, after the predetermined time TMf elapses, the charging control portion 74 terminates the charging-start-stage control CNcs and permits the main relay 40 to be switched to the OFF state based on the BLOW threshold value Vcelf.

If the main battery 20 withstands reduction of the cell voltage Vcel for a period until the plug-in charging is actually started during the predetermined time TMf, the cell voltage Vcel is recovered thereafter.

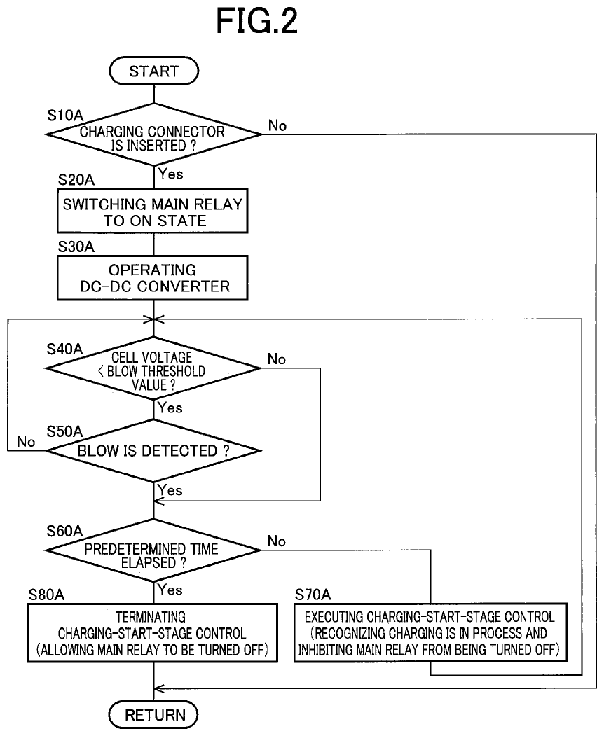

FIG. 2 is a flowchart showing a main part of the control operation of the electronic control apparatus 70, namely, a control routine that is executed for appropriately charging the main battery 20 by the AC charger 30 disposed on the electric path via the main relay 40, i.e., the electric path that is to be connected to and disconnected from the main battery 20 by switching of the main relay 40. This control routine is executed in a repeated manner, for example.

As shown in FIG. 2, the control routine is initiated with step S10A corresponding to function of the charging control portion 74, which is implemented to determine whether or not the charging connector 104 is connected to the charging inlet 34, that is, whether or not the charging connector 110 is inserted into the charging inlet 34. When a negative determination is made at step S10A, one cycle of execution of the control routine is terminated. When an affirmative determination is made at step S10A, the main relay 40 is switched to the ON state at step S20A corresponding to function of the charging control portion 74. Next, at step S30A corresponding to function of the electric-motor control portion 72, the DC-DC converter 52 is operated. Step S30A is followed by step S40A corresponding to the function of the charging control portion 74, which is implemented to determine whether or not the cell voltage Vcel is less than the BLOW threshold value Vcelf. When an affirmative determination is made at step S40A, step S50A corresponding to function of the charging control portion 74 is implemented to determine whether or not BLOW is detected. When a negative determination is made at step S50A, the control flow goes back to step S40A. When a negative determination is made at step S40A, or when an affirmative determination is made at step S50A, step S60A corresponding to function of the charging control portion 74 is implemented to determine whether or not the predetermined time TMf has elapsed. When a negative determination is made at step S60A, the control flow goes to step S70A at which the charging control portion 74 executes the charging-start-stage control CNcs by inhibiting the main relay 40 from being turned off based on the BLOW threshold value Vcelf. After implementation of step S70A, the control flow goes back to step S40A. When an affirmative determination is made at step S60A, step S80A corresponding to function of the charging control portion 74 is implemented to terminate the charging-start-stage control CNcs and allow switching of the main relay 40 to the OFF state based on the BLOW threshold value Vcelf. During a period until the affirmative determination is made at step S60A, the plug-in charging is actually started and the cell voltage Vcel is recovered.

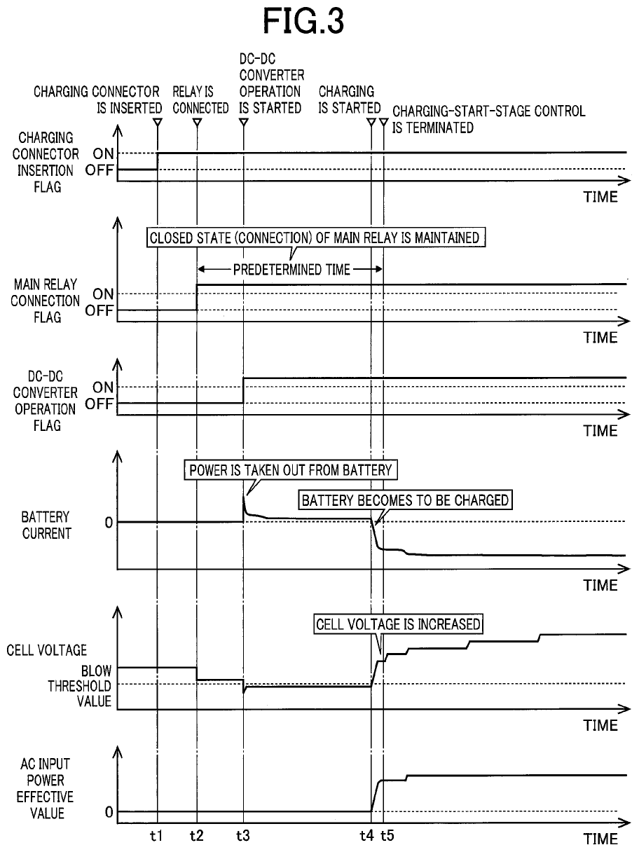

FIG. 3 is a view showing, by way of example, a time chart in a case where the control operation shown in the flowchart of FIG. 2 is executed. FIG. 3 shows an example of a case where the plug-in charging is performed when the cell voltage Vcel is in the vicinity of the BLOW threshold value Vcelf. In FIG. 3, a time point t1 indicates a time point at which the charging connector 104 is inserted into the charging inlet 34. When the charging connector 104 is inserted into the charging inlet 34, a charging control CNchg is executed. In the charging control CNchg, the main relay 40 is switched to ON (see a time point t2), and thus the DC-DC converter 52 is operated (see a time point t3). The plug-in charging is actually started after the above-described predetermined preparation time elapses (see a time point t4). When the DC-DC converter 52 is operated, the electric power is taken out from the main battery 20. At this time, if the cell voltage Vcel is in the vicinity of the BLOW threshold value Vcelf, the cell voltage Vcel is made lower than the BLOW threshold value Vcelf, so that the BLOW condition is established. When the BLOW condition is continuously satisfied for the detection determination time TMblow, the BLOW is detected. In contrast, in the present embodiment, the charging-start-stage control CNcs is executed until the predetermined time TMf elapses after the main relay 40 is switched to the ON state, and thus, even when the BLOW is detected, the switching of the main relay 40 to the OFF state is inhibited. The cell voltage Vcel is recovered by actually starting the plug-in charging before the predetermined time TMf elapses. When the predetermined time TMf elapses, the charging-start-stage control CNcs is terminated (see a time point t5).

As described above, according to the present embodiment, in the plug-in charging, the charging-start-stage control CNcs is executed such that the main relay 40 is maintained in the ON state until the predetermined time TMf elapses after the main relay 40 is switched to the ON state in response to the connection of the external power source 100. Thus, after the main relay 40 is switched to the ON state, the switching of the main relay 40 to the OFF state is avoided or suppressed until the plug-in charging is actually started. Therefore, the main battery 20 can be appropriately charged by the AC charger 30 which is arranged in parallel with the electric-power control unit 50 and which is disposed on the electric path that is to be connected to and disconnected from the main battery 20 by switching of the main relay 40.

Further, according to the present embodiment, the charging-start-stage control CNcs is executed by inhibiting the main relay 40 from being switched to the OFF state even when the cell voltage Vcel becomes lower than the BLOW threshold value Vcelf. Thus, the main relay 40 is appropriately maintained in the ON state until the predetermined time TMf elapses.

According to the present embodiment, after the predetermined time TMf elapses, the charging-start-stage control CNcs is terminated, and the switching of the main relay 40 to the OFF state when the cell voltage Vcel is lower than the BLOW threshold value Vcelf. Thus, deterioration of the durability of the battery cells 22 is appropriately suppressed.

Next, another embodiment of the present disclosure will be described. The same reference signs as used in the above-described embodiment will be used in the following embodiment, to identify the practically corresponding elements, and descriptions thereof are not provided.

### Second Embodiment

In the plug-in charging, even if the cell voltage Vcel is in the vicinity of the BLOW threshold value Vcelf, the cell voltage Vcel is less likely to be reduced below the BLOW threshold value Vcelf unless the DC-DC converter 52 is operated when the main relay 40 is switched to the ON state.

In the present embodiment, the charging control portion 74 executes the charging-start-stage control CNcs by not operating the DC-DC converter 52 when the main relay 40 is switched to the ON state. That is, the charging control portion 74 executes the charging-start-stage control CNcs by inhibiting the operation of the DC-DC converter 52 in conjunction with the switching of the main relay 40 to the ON state by the electric-motor control portion 72. After the predetermined time TMf elapses, the charging control portion 74 terminates the charging-start-stage control CNcs and releases the inhibition of the operation of the DC-DC converter 52. Thus, the electric-motor control portion 72 operates the DC-DC converter 52 after the predetermined time TMf elapses.

If the auxiliary battery 60 withstands the load brought out by the vehicle auxiliary devices 62 or the like for a period until the plug-in charging is actually started during the predetermined time TMf, the DC-DC converter 52 is operated thereafter.

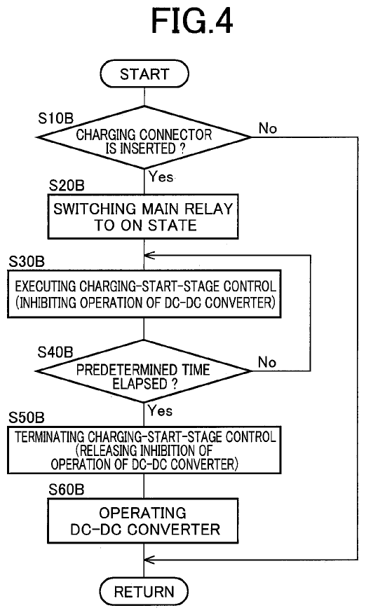

FIG. 4 is a flowchart showing a main part of the control operation of the electronic control apparatus 70, namely, a control routine that is executed for appropriately charging the main battery 20 by the AC charger 30 disposed on the electric path via the main relay 40, in a manner different from the flowchart of FIG. 2. This control routine is executed in a repeated manner, for example.

As shown in FIG. 4, the control routine is initiated with step S10B corresponding to function of the charging control portion 74, which is implemented to determine whether or not the charging connector 104 is inserted into the charging inlet 34. When a negative determination is made at step S10B, one cycle of execution of the control routine is terminated. When an affirmative determination is made at step S10B, the main relay 40 is switched to the ON state at step S20B corresponding to function of the charging control portion 74. Next, at step S30B corresponding to function of the charging control portion 74, the charging-start-stage control CNcs is executed by inhibiting the operation of the DC-DC converter 52 in conjunction with the switching of the main relay 40 to the ON state. Next, at step S40B corresponding to function of the charging control portion 74, it is determined whether or not the predetermined time TMf has elapsed. When a negative determination is made at step S40B, the control flow goes back to step S30B. When an affirmative determination is made at step S40B, step S50B corresponding to function of the charging control portion 74 is implemented to terminate the charging-start-stage control CNcs and to release the inhibition of the operation of the DC-DC converter 52. Next, at step S60B corresponding to function of the electric-motor control portion 72, the DC-DC converter 52 is operated. The plug-in charging is actually started during a period until the affirmative determination is made at step S40B.

As described above, according to the present second embodiment, similarly to the first embodiment, in the plug-in charging, the charging-start-stage control CNcs is executed such that the main relay 40 is maintained in the ON state until the predetermined time TMf elapses after the main relay 40 is switched to the ON state in response to the connection of the external power source 100. Therefore, the same effects as those of the first embodiment can be obtained.

According to the present embodiment, the charging-start-stage control CNcs is executed by inhibiting the operation of the DC-DC converter 52. Thus, the main relay 40 is appropriately maintained in the ON state until the predetermined time TMf elapses.

Further, according to the present embodiment, after the predetermined time TMf elapses, the charging-start-stage control CNcs is terminated, and the inhibition of the operation of the DC-DC converter 52 is released. Thus, a decrease in the durability of the auxiliary battery 60 is appropriately suppressed.

Although the embodiments of the present disclosure have been described in detail with reference to the drawings, the present disclosure is also applicable to other forms.

For example, in the above-described first embodiment, if the determination to detect the BLOW is not made, the switching of the main relay 40 to the OFF state based on the BLOW threshold value Vcelf is not executed so that the ON state of the main relay 40 is maintained. The charging control portion 74 may execute the charging-start-stage control CNcs by not determining whether the cell voltage Vcel is less than the BLOW threshold value Vcelf or by not determining whether the BLOW is detected.

In the above-described embodiments, the predetermined time TMf may be set to a time equivalent to the predetermined preparation time for driving the AC charger 30.

In the above-described embodiments, the electric vehicle may be a so-called plug-in hybrid electric vehicle that includes an engine and an electric motor and is capable of charging a high-voltage battery with an electric power supplied from an external power source.

It is to be understood that the embodiments described above are given for illustrative purpose only, and that the present disclosure may be embodied with various modifications and improvements which may occur to those skilled in the art.

### NOMENCLATURE OF ELEMENTS

10: electric vehicle
20: main battery (high-voltage battery)
22: battery cell
30: AC charger (charger)
40: main relay (relay)
50: electric-power control unit (electric-power control device)
52: DC-DC converter (electric voltage converter)
60: auxiliary battery (low-voltage battery)
62: vehicle auxiliary device
70: electronic control apparatus (control apparatus)
100: external power source
MG: electric motor

What is claimed is:

1. An electric vehicle comprising:
an electric motor;
a driving high-voltage battery including a plurality of battery cells connected in series;
an electric-power control device including an electric-voltage converter configured to reduce a voltage of a DC electric power supplied from the high-voltage battery and to supply the electric power to a low-voltage battery and vehicle auxiliary devices, the electric-power control device being configured to control the electric power transmitted and received between the high-voltage battery and the electric motor;
a relay that is to be switched between an open state and a closed state, such that an electric path between the high-voltage battery and the electric-power control device is cut off when the relay is placed in the open state, and is established when the relay is placed in the closed state;
a charger configured to charge the high-voltage battery with the electric power supplied from an external power source; and
a control apparatus configured to control charge of the high-voltage battery,
wherein the charger is arranged in parallel with the electric-power control device, and is disposed on an electric path that is to be connected to and disconnected from the high-voltage battery by switching of the relay,
wherein the control apparatus is configured to cause the electric-voltage converter to be operated when the relay is switched to the closed state,
wherein the control apparatus is configured to switch the relay to the open state when a voltage of the battery cells becomes lower than a predetermined low voltage value, and
wherein the control apparatus is configured, when the high-voltage battery is to be charged by the charger, to execute a charging-start-stage control by which the closed state of the relay is maintained until a predetermined time elapses after the relay is switched to the closed state in response to connection of the external power source, the predetermined time being predetermined as a period in which the charger actually starts charging the high-voltage battery and the voltage of the battery cells is increased.

2. The electric vehicle according to claim 1,
wherein the control apparatus is configured to execute the charging-start-stage control, by inhibiting the relay from being switched to the open state even when the voltage of the battery cells becomes lower than the predetermined low voltage value.

3. The electric vehicle according to claim 2,
wherein the control apparatus is configured, after elapse of the predetermined time, to terminate the charging-start-stage control, and to allow the relay to be switched to the open state when the voltage of the battery cells is lower than the predetermined low voltage value.

4. The electric vehicle according to claim 1,
wherein the control apparatus is configured to execute the charging-start-stage control, by inhibiting the electric-voltage converter from being operated.

5. The electric vehicle according to claim 4,
wherein the control apparatus is configured, after elapse of the predetermined time, to terminate the charging-start-stage control, and to cause the electric-voltage converter to be operated.
